(19) United States
(12) Patent Application Publication
(10) Pub. No.: US 2013/0108463 A1
(43) Pub. Date: May 2, 2013

(54) MATING STRUCTURE AND METHOD OF FORMING A MATING STRUCTURE

(71) Applicants: Yagnesh Dalpatbhai Hathiwala, Navsari (IN); Somayajula Kishore Kumar, Bangalore (IN); Hariharan Sundaram, Bangalore (IN)

(72) Inventors: Yagnesh Dalpatbhai Hathiwala, Navsari (IN); Somayajula Kishore Kumar, Bangalore (IN); Hariharan Sundaram, Bangalore (IN)

(73) Assignee: GENERAL ELECTRIC COMPANY, Schenectady, NY (US)

(21) Appl. No.: 13/283,281

(22) Filed: Oct. 27, 2011

(51) Int. Cl. F01D 25/00; B05D 7/14; B32B 3/02; B32B 3/14; B32B 15/01; B05D 5/00; B05D 1/02

(52) U.S. Cl. 416/244 R; 427/287; 427/142; 428/78; 428/614; 428/68

(57) ABSTRACT

A mating structure is provided and includes a first article having a first mating surface formed of a metallic material, a second article having a second mating surface, the second article being disposed such that the first and second mating surfaces mate with one another and a coating disposed on the first mating surface, which is formed of a material having a hardness that is higher than that of the metallic material of the first article. The coating has dimensions exceeded by corresponding dimensions of the first article.

### BACKGROUND OF THE INVENTION

The subject matter disclosed herein relates to a mating structure and, more particularly, a mating structure having a coating with increased hardness.

Conventional gas turbines have rotor wheels mounted with blades and buckets, which are stacked together either by press fittings or by the effects of heating/cooling methods along with tie-rods. One of the key features of a gas turbine rotor is a wheel-centering feature referred to as a rabbet, which enables all the wheels to be aligned with their center axis.

During turbine operations, mating surfaces become damaged due to the wedging contact between the rabbets and relative motion between the wheels. This might be due to variety of reasons like thermal gradients, vibration and bending loads. Also wear is observed in the rotor due the relative motion of blades and buckets with respect to wheels.

### BRIEF DESCRIPTION OF THE INVENTION

According to one aspect of the invention, a mating structure is provided and includes a first article having a first mating surface formed of a metallic material, a second article having a second mating surface, the second article being disposed such that the first and second mating surfaces mate with one another and a coating disposed on the first mating surface, which is formed of a material having a hardness that is higher than that of the metallic material of the first article. The coating has dimensions exceeded by corresponding dimensions of the first article.

According to another aspect of the invention, a method of forming a mating structure is provided and includes defining, in an article having a mating surface formed of a metallic material, a mating region having dimensions exceeded by corresponding dimensions of the article, defining, in the article, a coating region having dimensions exceeded by corresponding dimensions of the article and in excess of the corresponding dimensions of the mating region and replacing the metallic material of the article in the coating region with a coating formed of a material having a hardness that is higher than that of the metallic material of the article

According to yet another aspect of the invention, a method of repairing a defective structure is provided and includes defining, in an article having a defective surface formed of a metallic material, a coating region having dimensions exceeded by corresponding dimensions of the article and in excess of corresponding dimensions of the defective surface and replacing the metallic material of the article in the coating region with a coating formed of a material having a hardness that is higher than that of the metallic material of the article.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a mating structure in accordance with embodiments;

FIG. 2 is a perspective view of compressor or turbine wheels having wheel centering features;

FIG. 3 is a perspective view of turbine blades having dovetail pressure faces;

FIG. 4 is a perspective view of a crack propagating in a turbine blade platform;

FIG. 5 is a perspective view of a coating region having been removed from the turbine blade platform of FIG. 4;

FIG. 6 is a perspective view of a deposition of a coating into the coating region of FIG. 5;

FIG. 7 is a perspective of the coating of FIG. 6 having been trimmed; and

FIG. 8 is a cross-sectional view of the trimmed coating of FIG. 7.

The detailed description explains embodiments of the invention, together with advantages and features, by way of example with reference to the drawings.

### DETAILED DESCRIPTION OF THE INVENTION

Damage of turbine mating surfaces may be prevented or substantially reduced by applying a surface coating formed of a material having a hardness that is higher than the parent wheel material on the mating surfaces. A key challenge in accomplishing such an application is normally related to wear of this coating due to differences of coefficients of thermal expansion between the parent metal and the coating material. In accordance with aspects of the present invention, however, coating of Chromium, Molybdenum and Vanadium (CrMoV) or an alloy thereof may be accomplished with Chromium, Molybdenum, Vanadium and Boron (CrMoV-B) and, in some cases, Iron. That is, the base material (CrMoV) is boronized with boron in the range of 0.001% to 0.05% by weight. Since the amount of Boron in the coating is relatively less (0.001% to 0.05% by weight), significant changes in the coefficient of thermal expansion are not expected. Boronizing enables extremely hard borides to be placed on the mating surfaces, which will prevent wear at the joints.

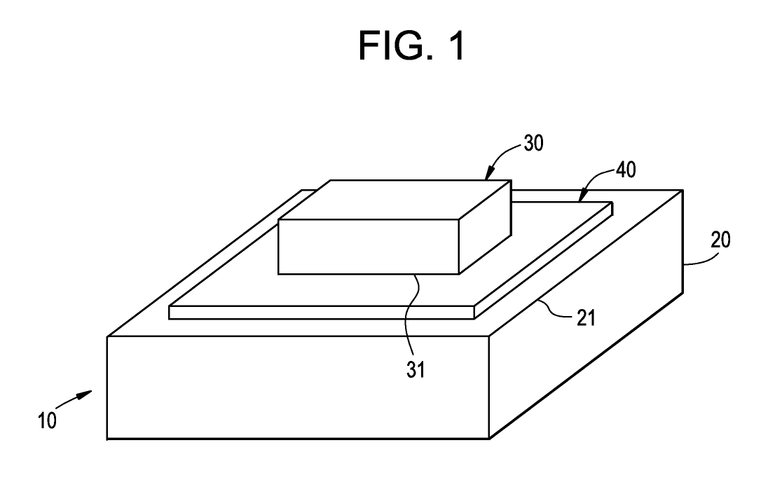

With reference to FIG. 1, a mating structure 10 is provided and includes a first article 20 having a first mating surface 21 formed of a metallic material, a second article 30 having a second mating surface 31 and a coating 40. The second article 30 is disposed relative to the first article 20 such that the first and second mating surfaces 21 and 31 mate with one another. The coating 40 is disposed on the first mating surface 21 and is formed of a material having a hardness value that is higher than that of the metallic material of the first article 20. The coating 40 has length, width and depth dimensions that are less than corresponding dimensions of the first article 20.

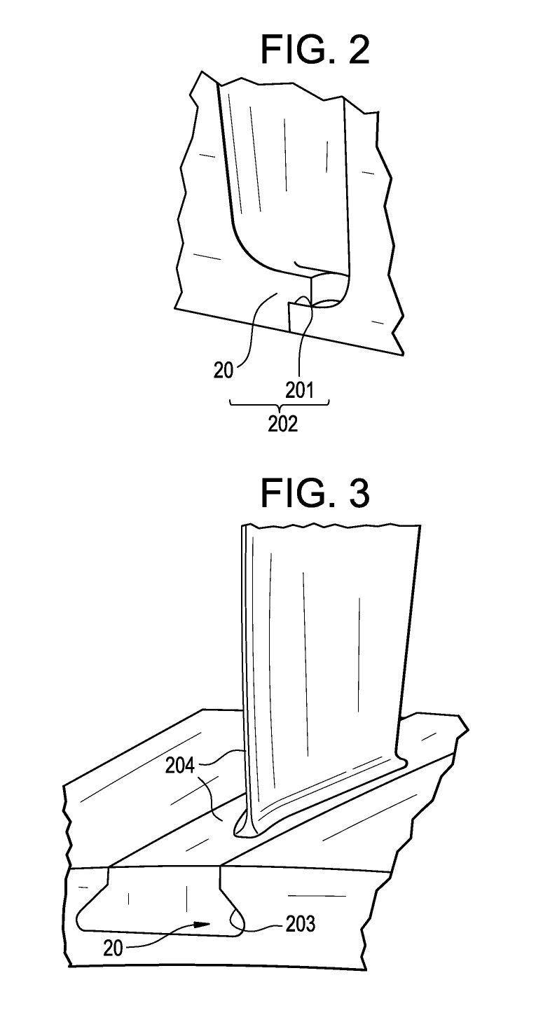

With reference to FIG. 2, the first article 20 may be a wheel centering feature or “rabbet” 201 of a turbine blade stage or platform 202. With reference to FIG. 3, the first article 20 may be a dovetail pressure face 203 of a turbine blade 204. In each of these and/or other exemplary cases, the metallic material of the first article 20 includes Chromium, Molybdenum and Vanadium may include any one or more of Iron, Nickel, Manganese, Carbon, Sulfur and Copper. The material of the coating 40 may be substantially similar to the metallic material of the first article 20 with Boron and/or Borides added. In accordance with embodiments, the material of the coating 40 may include 0.001 (±0.005) wt % to about 0.01 wt % of Boron. That is, the material of the coating 40 may be substantially similar to the metallic material of the first article 20 with Boronization and, in some cases, at least one or more of Carbo-Siliconization, Siliconization, Nitridization, Nickel Aluminidization and Carburization.

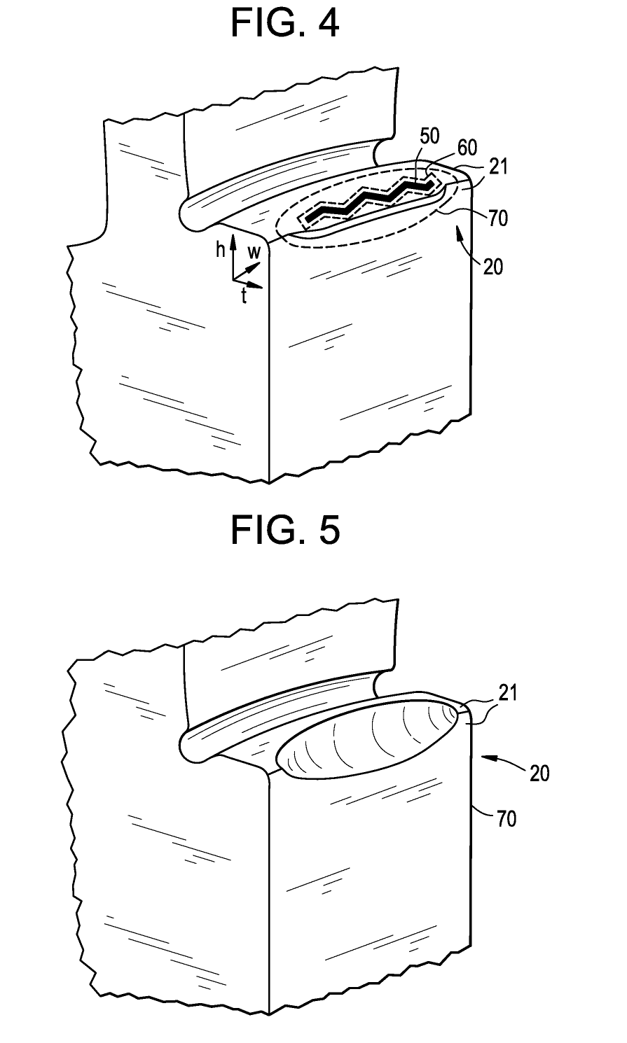

With reference to FIGS. 4-8, the coating 40 may have a regular or irregular shape. Also, the first article 20 may include a portion 210 surrounding the coating 40 and having an outer surface 211. The coating 40 may similarly include and outer surface 402 and be shaped such that the respective outer surfaces 211 and 402 are substantially coplanar and/or smooth.

Still referring to FIGS. 4-8, a method of forming a mating structure 10 is generally provided. The method is illustrated in FIGS. 4-8 and described below as being employed in a particular case where the mating structure 10 is provided to repair a crack 50. However, it is to be understood that this case is merely exemplary and not intended to limit the scope of the description or the claims appended hereto.

As shown in FIG. 4, the method includes defining, a mating region 60 about a defect or exemplary crack 50 in an article, such as first article 20 having, for example, a first mating surface 21 and being formed of a metallic material, as described above. The mating region 60 should have width, w, thickness, t, and height, h, dimensions that are more than corresponding dimensions of the defect or the exemplary crack 50 and less than corresponding dimensions of the first article 20. The method further includes defining a coating region 70 in the first article 20. The coating region 70 has width, w, thickness, t, and height, h, dimensions that are less than corresponding dimensions of the first article 20 and more than the corresponding dimensions of the mating region 60. Thus, the mating region 60 is larger in each dimension than the defect or the crack 50, the coating region 70 is larger in each dimension than the mating region 60 and the first article 20 is larger in each dimension than the coating region 70.

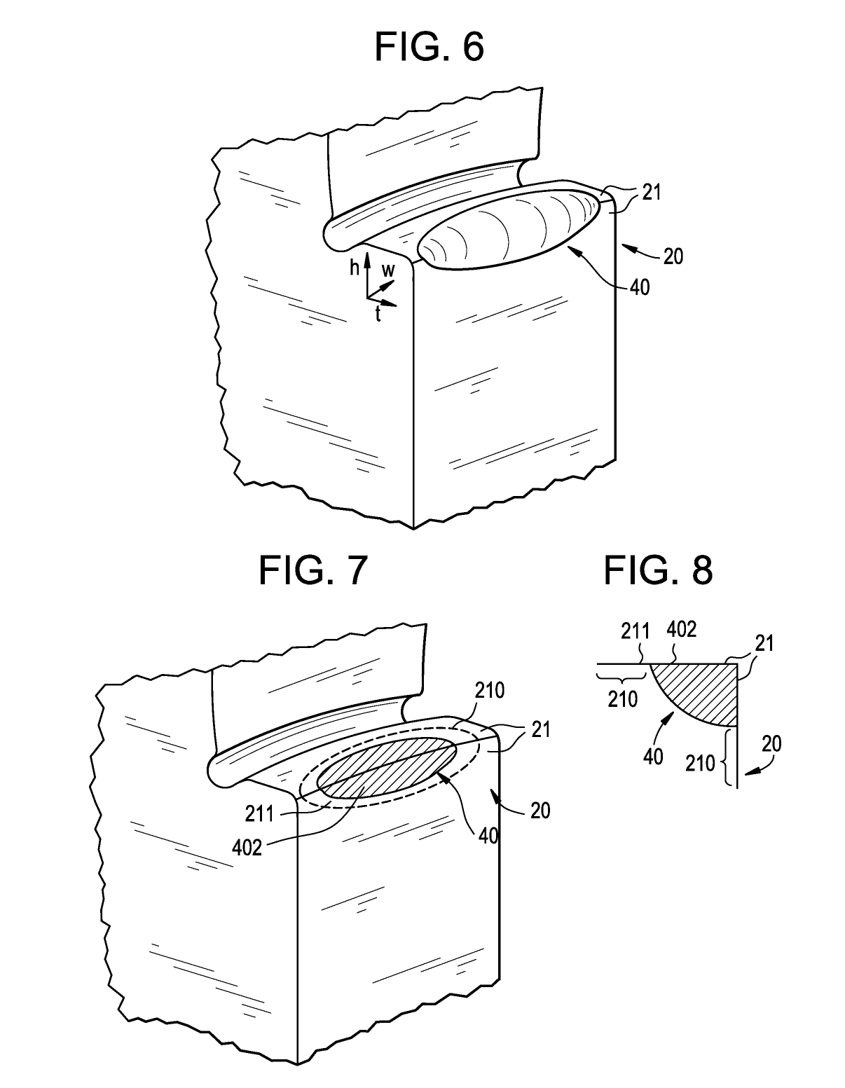

As shown in FIGS. 5-8, the method further includes replacing the metallic material of the coating region 70, which is defined in the first article 20 as described above, with coating 40. Again, the coating 40 is formed of a material having a hardness that is higher than that of the metallic material of the first article 20 and includes the materials described above. The replacing includes removing the metallic material of the first article 20 from the coating region 70 (see FIG. 5), applying the coating 40 (see FIG. 6) and trimming excess coating 40 (see FIGS. 7 and 8). The applying of the coating 40 includes applying the coating 40 such that the coating 40 has width, w, thickness, t, and height, h, dimensions that exceed the corresponding dimensions of the coating region 70. The trimming of the excess coating 40 is conducted such that the coating 40 has width, w, thickness, t, and height, h, dimensions that are substantially similar to the corresponding dimensions of the coating region 70.

In accordance with embodiments, the removing of the metallic material of the first article 20 and the trimming of the coating 40 may each include a machining of the coating region 70 or some other similar process. The applying may include spray deposition of the coating 40 and metallurgical bonding of the coating 40 to the first article 20. In general, any spray process that delivers a dense, mechanically strong coating 40 would be available as a workable option.

In accordance with further embodiments, the approach of FIGS. 4-8 can be applied in a repair operation of various articles and structures. For example, compressor casings often experience wear of slots that hold square base stator blades. The approach of FIGS. 4-8 could be used to repair those compressor casing slots. In further examples, the approach of FIGS. 4-8 could be used to repair compressor flow path damage, turbine casing nozzle support hooks, split-line sealing surfaces of any casing and/or cracks in nodular iron casings at flange and axial joints.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A mating structure, comprising:
a first article having a first mating surface formed of a metallic material;
a second article having a second mating surface, the second article being disposed such that the first and second mating surfaces mate with one another; and
a coating disposed on the first mating surface, which is formed of a material having a hardness that is higher than that of the metallic material of the first article,
the coating having dimensions exceeded by corresponding dimensions of the first article.

2. The mating structure according to claim 1, wherein the first article comprises one or more of a wheel centering feature of a turbine, a rabbet of a turbine blade platform and a dovetail pressure face of a turbine blade.

3. The mating structure according to claim 1, wherein the material of the coating is the metallic material of the first article with Boron added.

4. The mating structure according to claim 1, wherein the material of the coating is the metallic material of the first article with about 0.001 wt % to about 0.05 weight % of Boron.

5. The mating structure according to claim 1, wherein the material of the coating is the metallic material of the first article with Borides added.

6. The mating structure according to claim 1, wherein the material of the first article comprises Chromium, Molybdenum and Vanadium, and
wherein the material of the coating comprises Chromium, Molybdenum, Vanadium, Boron and Iron.

7. The mating structure according to claim 6, wherein the materials of the first article and the coating further comprise Iron, Nickel, Manganese, Carbon, Sulfur, and Copper.

8. The mating structure according to claim 1, wherein the material of the coating is the metallic material of the first article with Boronization and at least one or more of Carbo-Siliconization, Siliconization, Nitridization, Nickel Aluminidization and Carburization.

9. The mating structure according to claim 1, wherein the coating has an irregular shape.

10. The mating structure according to claim 1, wherein the first article comprises a portion surrounding the coating, respective outer surfaces of the portion of the first article and the coating being substantially coplanar.

11. A method of forming a mating structure, comprising:
defining, in an article having a mating surface formed of a metallic material, a mating region having dimensions exceeded by corresponding dimensions of the article;
defining, in the article, a coating region having dimensions exceeded by corresponding dimensions of the article and in excess of the corresponding dimensions of the mating region; and
replacing the metallic material of the article in the coating region with a coating formed of a material having a hardness that is higher than that of the metallic material of the article.

12. The method according to claim 11, wherein the replacing comprises:
removing the metallic material of the article from the coating region;
applying the coating with dimensions in excess of the dimensions of the coating region; and
trimming excess coating such that the coating has dimensions substantially similar to the corresponding dimensions of the coating region.

13. The method according to claim 12, wherein the removing and the trimming each comprise machining of the coating region.

14. The method according to claim 12, wherein the applying comprises forming the coating as the metallic material of the article with Boron added.

15. The method according to claim 12, wherein the applying comprises:
spray deposition of the coating; and
metallurgical bonding of the coating to the article.

16. A method of repairing a defective structure, comprising:
defining, in an article having a defective surface formed of a metallic material, a coating region having dimensions exceeded by corresponding dimensions of the article and in excess of corresponding dimensions of the defective surface; and
replacing the metallic material of the article in the coating region with a coating formed of a material having a hardness that is higher than that of the metallic material of the article.

17. The method according to claim 16, wherein the replacing comprises:
removing the metallic material of the article from the coating region;
applying the coating with dimensions in excess of the dimensions of the coating region; and
trimming excess coating such that the coating has dimensions substantially similar to the corresponding dimensions of the coating region.

18. The method according to claim 17, wherein the removing and the trimming each comprise machining of the coating region.

19. The method according to claim 17, wherein the applying comprises forming the coating as the metallic material of the article with Boron added.

20. The method according to claim 17, wherein the applying comprises:
spray deposition of the coating; and
metallurgical bonding of the coating to the article.
